(19) United States
(12) Patent Application Publication
(10) Pub. No.: US 2007/0024652 A1
(43) Pub. Date: Feb. 1, 2007

(54) Method and apparatus for printing

(75) Inventors: Lucas D. Barkley, Lexington, KY (US); Gregory S. Woods, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/193,577

(22) Filed: Jul. 29, 2005

(51) Int. Cl. B41J 29/38

(52) U.S. Cl. 347/10

(57) ABSTRACT

A method of printing using a printhead, the printhead having a plurality of ink ejectors and a plurality of jetting heaters corresponding to the plurality of ink ejectors includes applying a first waveform to the plurality of jetting heaters prior to a printing operation to warm up the printhead to a desired printhead operating temperature; applying a second waveform to a first portion of the plurality of jetting heaters during the printing operation to print an image without applying the first waveform to any of the plurality of jetting heaters; and applying a third waveform different from the first waveform to a second portion of the plurality of jetting heaters different from the first portion during the printing operation to maintain the desired printhead operating temperature.

### BACKGROUND OF THE INVENTION

1. Field of the Invention

The present invention relates to printing, and, more particularly, to a method and apparatus for printing.

2. Description of the Related Art

In the present thermal inkjet industry, achieving a desired printhead operating temperature before printing (pre-heat) is performed in order to achieve acceptable print quality. This temperature must then be maintained during printing operations, and is typically performed using a substrate heater, or by using the ink jetting heaters to heat the chip by applying electrical power to the jetting heaters that yields a heating amount insufficient for ink ejection, referred to herein as a non-nucleating heating (NNH), but is sufficient to heat the substrate at an acceptable rate to achieve operating temperature within an acceptable amount of time and then to maintain the operating temperature. However, NNH heating may adversely affect print quality by disturbing the flow of power to the jetting heaters that are currently printing.

What is needed in the art is an improved method and apparatus for printing.

### SUMMARY OF THE INVENTION

The present invention provides an improved method and apparatus for printing.

The invention, in one exemplary embodiment, relates to a method of printing using a printhead, the printhead having a plurality of ink ejectors and a plurality of jetting heaters corresponding to the plurality of ink ejectors. The method includes applying a first waveform to the plurality of jetting heaters prior to a printing operation to warm up the printhead to a desired printhead operating temperature; applying a second waveform to a first portion of the plurality of jetting heaters during the printing operation to print an image without applying the first waveform to any of the plurality of jetting heaters; and applying a third waveform different from the first waveform to a second portion of the plurality of jetting heaters different from the first portion during the printing operation to maintain the desired printhead operating temperature.

The invention, in another exemplary embodiment, relates to an imaging apparatus. The imaging apparatus includes a print engine, a printhead communicatively coupled to the print engine, the printhead having a plurality of ink ejectors and a plurality of jetting heaters corresponding to the plurality of ink ejectors, and a controller communicatively coupled to the print engine. The controller is configured to execute instructions for printing using the printhead, the instructions including: applying a first waveform to the plurality of jetting heaters prior to a printing operation to warm up the printhead to a desired printhead operating temperature; applying a second waveform to a first portion of the plurality of jetting heaters during the printing operation to print an image without applying the first waveform to any of the plurality of jetting heaters; and applying a third waveform different from the first waveform to a second portion of the plurality of jetting heaters different from the first portion during the printing operation to maintain the desired printhead operating temperature.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 is an exemplary depiction of the printhead of FIG. 1, with the printhead being projected over a sheet of print media.

FIG. 3 depicts an ink ejection waveform including pre-fire and main fire pulses as applied to the jetting heaters of a printhead.

FIG. 4 depicts a waveform used for preheating the printhead.

FIG. 5 depicts the printhead preheating waveform of FIG. 4 in relation to the ink ejection waveform of FIG. 3.

FIG. 6 depicts the ink ejection waveform of FIG. 3 and the printhead preheating waveform of FIG. 4, along with the jetting heater current resulting from the application of the waveforms of FIGS. 3 and 4.

FIG. 7 depicts a printhead warming waveform that may be applied during a printing operation in accordance with the present invention.

FIG. 8 depicts the ink ejection waveform of FIG. 3 in relation to the printhead warming waveform of FIG. 7, along with the jetting heater current resulting from the application of the waveforms of FIGS. 3 and 7.

FIGS. 9A and 9B are a flowchart depicting a method of printing in accordance with the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

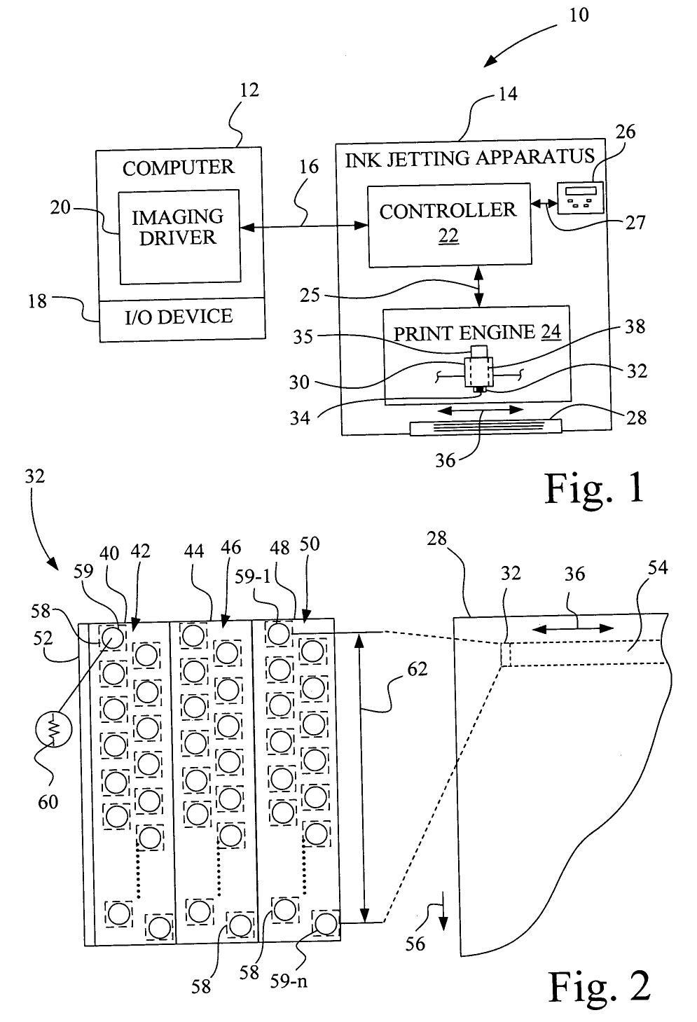

Referring to FIG. 1, there is shown a diagrammatic depiction of an imaging system 10 embodying the present invention. Imaging system 10 may include a computer 12 and an ink jetting apparatus 14. Ink jetting apparatus 14 communicates with computer 12 via a communications link 16. Communications link 16 may be established by a direct cable connection, wireless connection or by a network connection such as for example an Ethernet local area network (LAN).

Alternatively, ink jetting apparatus 14 may be a standalone unit that is not communicatively linked to a host, such as computer 12. For example, ink jetting apparatus 14 may take the form of an all-in-one, i.e., multifunction, machine that includes standalone copying and facsimile capabilities, in addition to optionally serving as a printer when attached to a host, such as computer 12.

Computer 12 may be, for example, a personal computer including an input/output (I/O) device 18, such as keyboard and display monitor. Computer 12 further includes a processor, input/output (I/O) interfaces, memory, such as RAM, ROM, NVRAM, and a mass data storage device, such as a hard drive, CD-ROM and/or DVD units. During operation, computer 12 includes in its memory a software program including program instructions that function as an imaging driver 20, e.g., printer driver software, for ink jetting apparatus 14. Although residing in computer 12, imaging driver 20 is considered herein to be a part of ink jetting apparatus 14.

In the example of FIG. 1, ink jetting apparatus 14 also includes a controller 22, a print engine 24 and a user interface 26.

Imaging driver 20 of computer 12 is in communication with controller 22 of ink jetting apparatus 14 via communications link 16. Imaging driver 20 facilitates communication between ink jetting apparatus 14 and computer 12, and may provide formatted print data to ink jetting apparatus 14, and more particularly, to print engine 24. Alternatively, however, all or a portion of imaging driver 20 may be located in controller 22 of ink jetting apparatus 14. For example, where ink jetting apparatus 14 is a multifunction machine having standalone capabilities, controller 22 of ink jetting apparatus 14 may include an imaging driver configured to support a copying function, and/or a fax-print function, and may be further configured to support a printer function. In the present embodiment, the imaging driver facilitates communication of formatted print data, as determined by a selected print mode, to print engine 24.

Controller 22 includes a processor unit and associated memory, and may be formed as an Application Specific Integrated Circuit (ASIC). Controller 22 communicates with print engine 24 via a communications link 25. Controller 22 communicates with user interface 26 via a communications link 27. Communications links 25 and 27 may be established, for example, by using standard electrical cabling or bus structures, or by wireless connection.

Print engine 24 may be, for example, an ink jet print engine configured for forming an image on a sheet of print media 28, such as a sheet of paper, transparency or fabric.

Print engine 24 may include, for example, a reciprocating printhead carrier 30, and at least one ink jet printhead 32 having one or more of a printhead temperature sensor 34. Associated with printhead 32 is a power supply 35 for supplying electrical signals to printhead 32 for printhead warming, and for ink ejection during printing operations. Power supply 35 is depicted in FIG. 1 as being adjacent to printhead 32 for purposes of illustration, and may be located at any convenient location, provided that power supply 35 is communicatively coupled to printhead 32.

Printhead carrier 30 transports ink jet printhead 32 and printhead temperature sensor 34 in a reciprocating manner in a bi-directional main scan direction 36 over an image surface of sheet of print media 28 during printing and/or sensing operations.

Printhead carrier 30 may be mechanically and electrically configured to mount, carry and facilitate one or more printhead cartridges 38, such as a monochrome printhead cartridge and/or one or more color printhead cartridges. Each printhead cartridge 38 may include, for example, an ink reservoir containing a supply of ink, to which at least one respective printhead 32 is attached. In order for print data from computer 12 to be properly printed by print engine 24, the rgb data generated by computer 12 is converted into data compatible with print engine 24 and printhead(s) 32.

In one system using cyan, magenta, yellow and black inks, printhead carrier 30 may carry four printheads, such as printhead 32, with each printhead carrying an ejector array dedicated to a specific color of ink, e.g., cyan, magenta, yellow and black. As a further example, a single printhead, such as printhead 32, may include multiple ink jetting arrays, with each array associated with one color of a plurality of colors of ink, and printhead carrier 30 may be configured to carry multiple printheads.

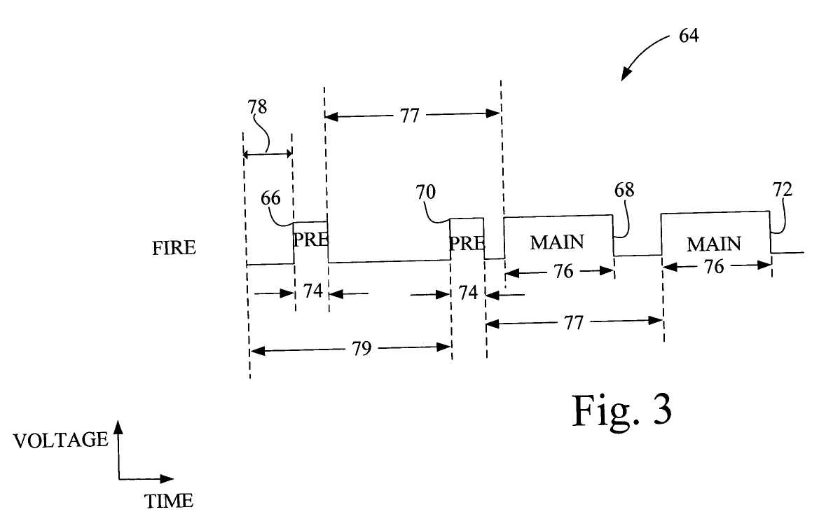

FIG. 2 shows one exemplary configuration of printhead 32, which includes a cyan nozzle plate 40 corresponding to an ink ejector array 42, a yellow nozzle plate 44 corresponding to an ink ejector array 46, and a magenta nozzle plate 48 corresponding to an ink ejector array 50, for respectively ejecting cyan (C) ink, yellow (Y) ink, and magenta (M) ink.

Printhead 32 may include a printhead memory 52 for storing information relating to printhead 32 and/or ink jetting apparatus 14. For example, memory 52 may be formed integral with printhead 32, or may be attached to printhead cartridge 38.

As further illustrated in FIG. 2, printhead carrier 30 is controlled by controller 22 to move printhead 32 in a reciprocating manner in main scan direction 36, with each left to right, or right to left movement of printhead carrier 30 along main scan direction 36 over the sheet of print media 28 being referred to herein as a pass. The area traced by printhead 32 over sheet of print media 28 for a given pass will be referred to herein as a swath, such as for example, swath 54 as shown in FIG. 2. The sheet of print media 28 may be advanced between passes in a media feed direction 56.

In the exemplary ink ejector configuration for ink jet printhead 32 shown in FIG. 2, each of ink ejector arrays 42, 46 and 50 include a plurality of ink ejectors 58, with each ink ejector 58 having a nozzle 59, and having at least one corresponding jetting heater 60.

A swath height 62 of swath 54 corresponds to the distance between the uppermost and lowermost of the nozzles within an array of nozzles of printhead 32. For example, in ink ejector array 50, nozzle 59-1 is the uppermost nozzle and nozzle 59-n is the lowermost nozzle. In the example of FIG. 2, the swath height 62 is the same for each of nozzle arrays 42, 46 and 50; however, this need not be the case, i.e., it is possible that the swath heights of nozzle arrays 42, 46 and 50 may be different, either by design or due to manufacturing tolerances.

Controller 22 provides individual temperature control for each jetting heater 60, respectively, for conditioning ink in one or more selected ink ejectors 58 of printhead 32, for example, to account for nozzle discharge variations, ink viscosity, ink vapor point, jetting heater resistance, ink ejector cavity volume, etc., so as to place the ink in the selected ink ejectors 58 in a desired condition prior to executing a main fire pulse to eject the ink. For example, each ink ejector 58 may be preheated to a respective predetermined temperature using a respective non-nucleating pre-fire pulse, on a per ejector basis. Ideally, each non-nucleating heater pulse is of duration that a vapor bubble is not formed in the liquid ink, and accordingly, no drop of ink is ejected from the corresponding ink ejector 58.

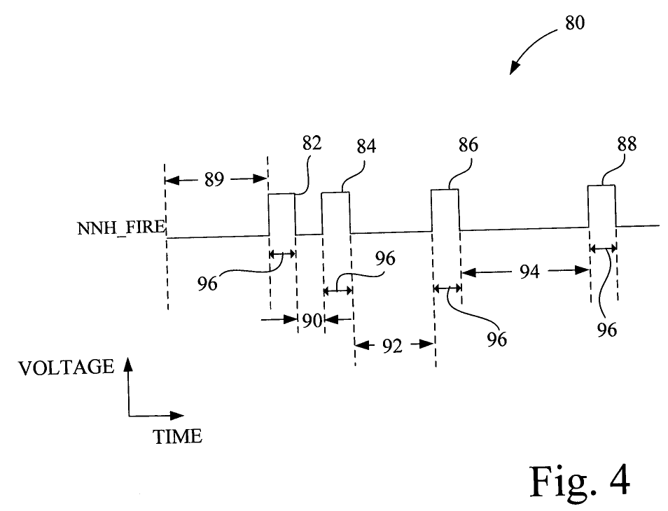

Referring now to FIG. 3, an ink ejection waveform 64 for printing by ejecting ink from ink ejectors 58 is depicted for one firing window, e.g., a single address cycle of printhead 32. Ink ejection waveform 64 is supplied to printhead 32 by power supply 35, and is controlled by controller 22. During a printing operation, controller 22 cycles through a series of N firing windows, wherein N=E/S, and wherein N is the total number of firing windows, E is the total number of ink ejectors 58 in printhead 32, and S is a number of subgroups of ink ejectors 58, each subgroup being those ink ejectors 58 that are fired during a given firing window.

Waveform 64 is a nucleating waveform having at least one nucleating pulse. During the printing operation, ink is ejected from selected ink ejectors 58 that are designated for printing in the current firing window by applying waveform 64 to printhead 32. As controller 22 cycles through each firing window, different ink ejectors 58 designated for printing in the respective particular firing windows are fired using waveform 64 in accordance with formatted image data to eject ink onto print media 28. For example, in the present embodiment, a first subset of ink ejectors 58 ejects ink using a pre-fire pulse 66 and a main fire pulse 68, and a second subset of ink ejectors 58 ejects ink using a pre-fire pulse 70 and a main fire pulse 72. Pre-fire pulse 66 and pre-fire pulse 70 are non-nucleating pre-fire pulses applied to the respective jetting heaters 60 for conditioning the ink in the corresponding ink ejectors 58 prior to ejecting the ink, whereas main fire pulse 68 and main fire pulse 72 are nucleating pulses that eject the ink from the respective ink ejectors 58 by locally vaporizing ink in the immediate vicinity of the respective jetting heaters 60, which creates a vapor bubble that displaces and expels the ink from the respective ink ejector 58 via the respective nozzles 59.

The pulse width, the temporal spacing between the pre-fire pulses and main fire pulses, and the temporal spacing from the initiation of the firing window, are controlled for optimal ink ejection, for example, depicted as pre-fire pulse width 74, main fire pulse width 76, temporal spacing 77, and temporal spacings 78 and 79, respectively. A plurality of address cycles having waveform 64 are employed to fire all ink ejectors 58 of printhead 32.

Prior to a printing operation, it is desirable to warm up printhead 32 in order to provide satisfactory ink ejection conditions for the ink ejectors 58 of printhead 32. In order to do so, controller 22 controls the temperature of printhead 32 based on using data from printhead temperature sensor 34. For example, in order to warm up the temperature of printhead 32 prior to printing, controller 22 may apply a waveform in the form of non-nucleating pulses to all ink ejectors 58 until a desired printhead operating temperature is attained.

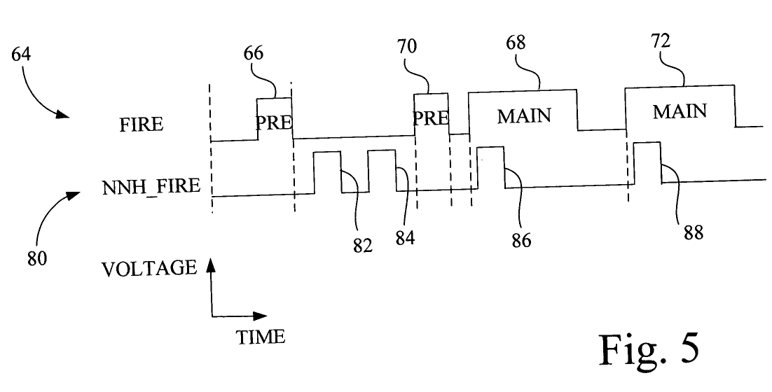

Referring now to FIG. 4, a preheating waveform 80 for warming up printhead 32 in a preheat mode is depicted. Preheating waveform 80 is supplied to printhead 32 by power supply 35, and is controlled by controller 22. Waveform 80 includes only non-nucleating heating (NNH) pulses for warming printhead 32, which are depicted in FIG. 4 as NNH warming pulse 82, NNH warming pulse 84, NNH warming pulse 86, and NNH warming pulse 88. Waveform 80 is configured, i.e., designed, to provide the maximum amount of non-nucleating heating so as to bring printhead 32 temperature up to the desired printhead temperature quickly, which dictates the pulse width, and the temporal spacing between the respective NNH warming pulses, depicted as temporal spacing 89 as from the initiation of the firing window, and temporal spacing 90, temporal spacing 92, and temporal spacing 94 as between the respective NNH warming pulse 82, NNH warming pulse 84, NNH warming pulse 86, and NNH warming pulse 88. In the present embodiment, each NNH warming pulse of waveform 80 has the same pulse width 96. Waveform 80 is also applied to all ink ejectors 58 as required to sustain the desired printhead temperature prior to a printing operation, based on feedback from printhead temperature sensor 34.

It will be understood by those skilled in the art that the printhead warming operation, including the waveform and corresponding pulses employed for the warming operation, e.g., waveform 80, is unrelated to the pre-fire pulses employed as part of ejecting ink, for example, pre-fire pulse 66 and pre-fire pulse 70 of waveform 64. For example, rather than conditioning ink in particular ink ejectors 58 prior to ink ejection by using waveform 64, the waveform employed for warming the printhead, e.g., waveform 80, is employed to bring the printhead bulk temperature to a desired level.

During printing operations, printhead carrier 30 is controlled by controller 22 to accelerate printhead 32 from an initial starting position into reciprocating motion in main scan direction 36, during which time controller 22 controls printhead 32 to fire various ink ejectors in response to image data to eject ink onto print media 28 to form a printed image. Between scans of printhead 32, print media 28 may be indexed in media feed direction 56 as required to complete the printed image.

Depending on conditions that affect the temperature of printhead 32 during printing operations, for example, external ambient temperature, internal temperature of ink jetting apparatus 14, and amount of heating caused during the ejection of ink to form the image, which varies depending upon the image input data, it is often necessary to apply heat to maintain printhead 32 at the desired operating temperature. For example, when printing text or images that do not require very much ink, not very many ink ejectors 58 are fired for printing, as compared to a richly colored photograph, wherein many ink ejectors 58 are fired and with a greater frequency. Hence, the amount of heating of printhead 32 caused by printing operations varies with printing conditions and other conditions, and may or may not be sufficient to maintain printhead 32 at the desired printhead operating temperature.

Accordingly, during printing operations, controller 22 provides additional heating to printhead 32 based on using data from printhead temperature sensor 34. For example, in order to maintain the temperature of printhead 32 during a printing operation, controller 22 may apply a waveform in the form non-nucleating pulses to all ink ejectors 58 except for those that are designated for ejecting ink during a given firing window (address cycle).

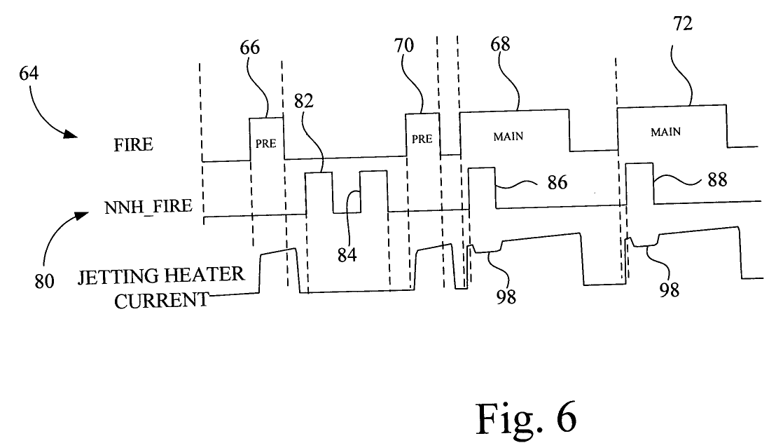

Referring now to FIG. 5, waveform 64 and waveform 80 are depicted together in relation to each other. Although it is possible that waveform 80 may be employed to maintain the desired printhead operating temperature, it is seen from FIG. 5 that main fire pulse 68 overlaps with NNH warming pulse 86, and main fire pulse 72 overlaps with NNH warming pulse 88. Although in the present embodiment a waveform employed to maintain the desired printhead operating temperature is not applied to any ink ejectors 58, i.e., to any jetting heaters 60, that are designated for ink ejection within the firing window, but rather, is applied only to ink ejectors 58 that are not designated for ink ejection within the given firing window, the fact that the pulses overlap may be problematic.

For example, the electrical resistances that exist between power supply 35 and jetting heaters 60 is significant enough to produce a voltage drop that increases with the number of jetting heaters 60 that are being energized for ink ejection and for printhead temperature control. This voltage drop causes the current to individual jetting heaters 60 to decrease with increased numbers of energized jetting heaters 60, which in turn decreases the total energy delivered to an individual jetting heater 60 over a prescribed amount of time. That is, electrical resistances between power supply 35 and jetting heaters 60 of printhead 32 may be such that a voltage drop is produced due to the electrical demand associated with applying NNH warming pulses to all non-firing jetting heaters 60 in addition to applying the fire pulses for jetting heaters 60 designated for printing.

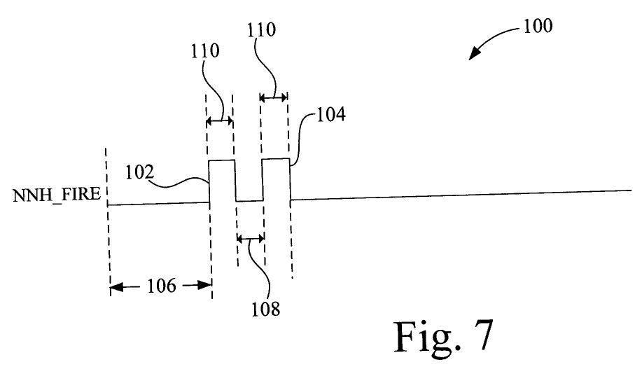

Referring now to FIG. 6, waveform 64 and waveform 80 are depicted together in relation to each other, along with a plot of the current in jetting heaters 60 designated for printing in the firing window. The current in the jetting heaters 60 designated for printing results primarily from the application of waveform 64 to those jetting heaters. However, the application of waveform 80 to the jetting heaters 60 that are not designated for printing causes a voltage drop, which yields a current drop 98 in jetting heaters 60 that are designated for printing. Such a current drop is undesirable because it adversely affects the results of the firing pulses of waveform 64 that were otherwise carefully designed to eject a desired amount of ink at a desired velocity, and may thus cause degraded print quality.

Although it may be possible to increase the capacity of power supply 35 and/or the associated wiring that connects power supply 35 to printhead 32 in order to prevent a current drop from occurring during a main firing pulse while providing temperature maintenance non-nucleating pulses to all non-printing jetting heaters 60 for printhead warming, doing so would increase the cost of ink jetting apparatus 14, which is undesirable.

During the preheat mode, the maximum deliverable heat energy without expelling ink is needed to heat the printhead rapidly to prepare for printing. However, once the operating temperature has been achieved, much less energy is needed to maintain the operating temperature. Accordingly, the present invention defines two separate NNH warming pulse profiles. One for preheat, and one for print-heat, which is the heating applied to printhead 32 for temperature maintenance during printing operations. In the present embodiment the NNH warming pulse profile, waveform 80, is employed for the preheat mode. However, for the print-heat mode, the NNH warming pulse profile employs the first two pulses between the pre-fire pulse 66 and pre-fire pulse 70, but the last two pulses which cause the disturbance during main fire pulse 68 and main fire pulse 72 are removed. Empirical data indicates that the energy delivered by the first two pulses alone is sufficient for maintaining the temperature achieved during the pre-heat mode.

Thus, the present invention includes applying different profiles of NNH pulsing based on the mode of operation in order to maintain performance and to maintain consistency in ink droplet formation and delivery.

Accordingly, the present invention includes defining a third waveform for temperature maintenance non-nucleating pulses for application to jetting heaters 60 that are not designated for printing in the firing window, the third waveform providing printhead warming to maintain the desired printhead operating temperature of printhead 32.

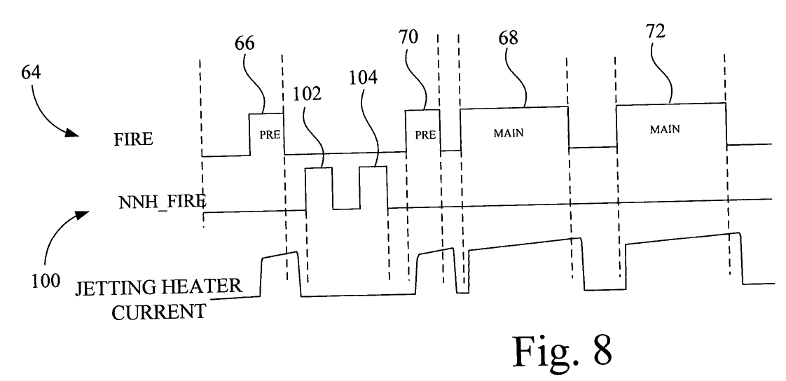

Referring now to FIG. 7, a temperature maintenance waveform 100 in accordance with the present invention is depicted. Temperature maintenance waveform 100 is supplied to printhead 32 by power supply 35, and is controlled by controller 22. Waveform 100 includes only non-nucleating heating (NNH) pulses for arming printhead 32, which are depicted in FIG. 7 as NNH warming pulse 102 and NH warming pulse 104. Waveform 100 is configured, i.e., designed, to provide on-nucleating heating so as to maintain printhead 32 at the desired printhead operating temperature, but without causing a current drop in jetting heaters 60 designated for printing, which dictates the temporal spacing between the respective NNH warming pulses, depicted as temporal spacing 106 and temporal spacing 108 as from the initiation of the firing window and as between NNH warming pulse 102 and NNH warming pulse 104, respectively. Accordingly, waveform 100 is configured to prevent a voltage drop in jetting heaters 60 designated for ink ejection during the current firing window for the duration of pre-fire pulse 66, main fire pulse 68, pre-fire pulse 70, and main fire pulse 72. In order to prevent the voltage drop, waveform 100 is synchronized with waveform 64 such that NNH warming pulses, e.g., NNH warming pulse 102 and NNH warming pulse 104, applied to jetting heaters 60 not designated for printing in the current firing window, do not overlap any of pre-fire pulse 66, main fire pulse 68, pre-fire pulse 70, and main fire pulse 72 that are applied to jetting heaters 60 that are designated for printing in the current firing window. In the present embodiment, waveform 100 provides less energy to a given jetting heater 60 and to printhead 32 than does waveform 80.

In the present embodiment, each NNH warming pulse of waveform 100 has the same pulse width 110, although different pulse widths may be employed without departing from the scope of the present invention. Also, in the present embodiment, waveform 100 is applied to all ink ejectors 58 not designated for printing in the current firing window, as required to maintain the desired printhead temperature during printing operations based on feedback from printhead temperature sensor 34. Alternatively, it is contemplated that waveform 100 may be applied to only selected ink ejectors 58, for example, depending upon print conditions. Nonetheless, waveform 100 is not applied to any jetting heaters 60 that are designated for printing within the current firing window.

It will be understood by those skilled in the art that the printhead temperature maintenance operation, including the waveform and corresponding pulses employed for the warming operation, e.g., waveform 100, is unrelated to the pre-fire pulses employed as part of ejecting ink, for example, pre-fire pulse 66 and pre-fire pulse 70 of waveform 64. For example, rather than conditioning ink in particular ink ejectors 58 prior to ink ejection by using waveform 64, the waveform employed for warming the printhead, e.g., waveform 100, is employed to maintain printhead 32 bulk temperature at the desired printhead operating temperature.

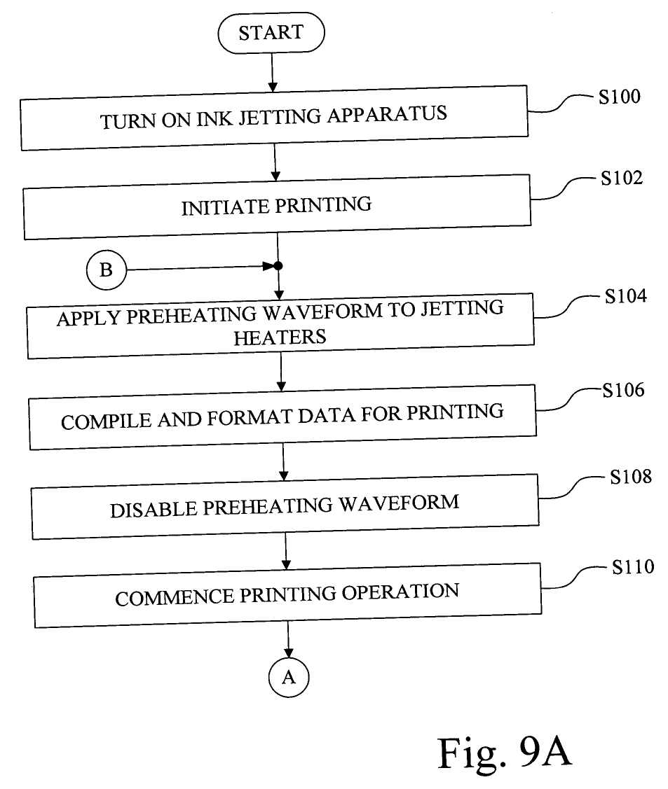

Referring now to FIG. 8, waveform 64 and waveform 100 are depicted together in relation to each other, along with a plot of the current in jetting heaters 60 designated for printing in the firing window. Unlike the plots of FIG. 6, by virtue of the present invention, it is seen that there is no current drop in the jetting heaters 60 designated for printing, since there is no overlap of the NNH warming pulses with the main firing nucleating pulses or the pre-fire pulses.

For example, in FIG. 8, NNH warming pulse 102 and NNH warming pulse 104 of waveform 100 do not occur at the same time as any of pre-fire pulse 66, main fire pulse 68, pre-fire pulse 70, and main fire pulse 72. Thus, there is no voltage drop produced since the electrical demand is reduced because there are no NNH warming pulses to any of non-firing jetting heaters 60 for the duration of time in which the pre-fire and main fire pulses are applied to jetting heaters 60 designated for printing.

Accordingly, the present invention has the advantage of not requiring an increase the capacity of power supply 35 and/or the associated wiring that connects power supply 35 to printhead 32 in order to prevent a current drop from occurring during a main firing pulse, while still providing temperature maintenance non-nucleating pulses to all non-printing jetting heaters 60 for printhead warming. Accordingly, a smaller power supply and associated wiring for connection to printhead 32 may be employed, thus reducing the cost of ink jetting apparatus 14.

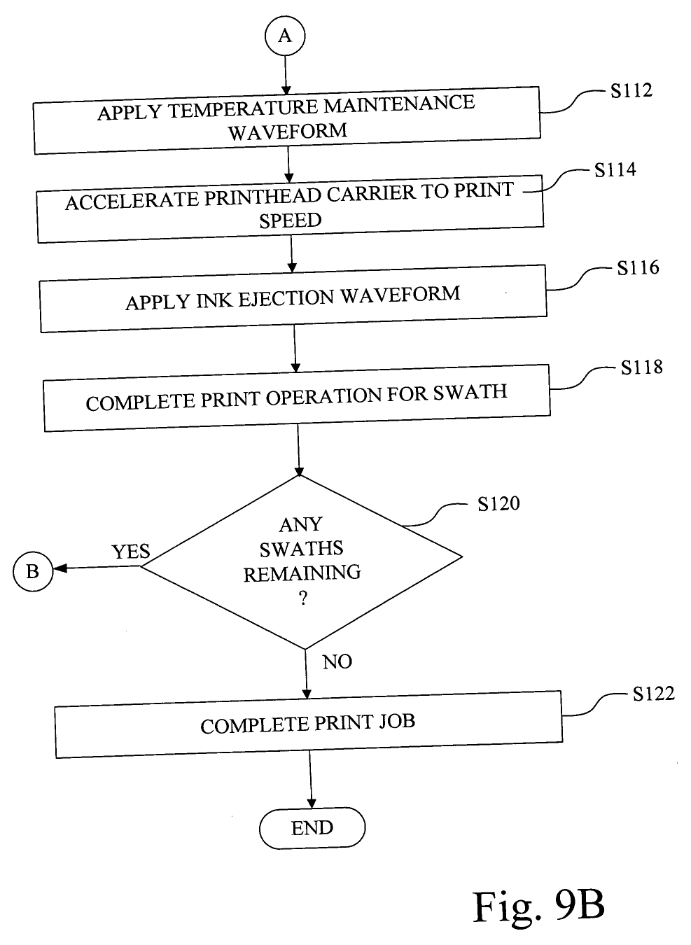

Referring now to FIG. 9A, a method of printing using printhead 32, with plurality of ink ejectors 58 and plurality of jetting heaters 60 corresponding to plurality of ink ejectors 58, in accordance with the present invention, is depicted. Unless otherwise indicated, each step is performed by controller 22 executing program instructions, for example, as part of imaging driver 20.

At step S100, a user turns on ink jetting apparatus 14, and controller 22 executes instructions to translate printhead carrier 30 with printhead 32 into a starting position in preparation for printing.

At step S102, the user initiates the printing of a document, for example, using conventional word or image processing software operating on computer 12.

At step S104, preheating waveform 80 is applied to the plurality of jetting heaters 60 prior to a printing operation to warm up printhead 32 to a desired printhead operating temperature. In the present embodiment, the desired operating temperature of printhead 32 is 42° C.

At step S106, print data is compiled and formatted for printing.

At step S108, the preheating waveform 80 is disabled, and hence, is no longer applied to jetting heaters 60 of printhead 32.

At step S110, the printing operation is commenced.

Referring now to FIG. 9B, at step S112, temperature maintenance waveform 100 is applied to jetting heaters 60 that are not designated for printing within the current firing window to maintain the desired printhead operating temperature during the printing operation based on using data from printhead temperature sensor 34. Thus, throughout the entire printing operation, waveform 100 is “turned on” or “turned off” based on feedback from printhead temperature sensor 34 as required to maintain the desired printhead operating temperature.

At step S114, printhead carrier 30 with printhead 32 is accelerated to print speed to begin printing swath 54. In the present embodiment, step S114 is executed approximately 200 μs after step S112 is initiated.

At step S116, ink ejection waveform 64 is enabled and applied to jetting heaters 60 that are designated for printing within the current firing window during the printing operation to print an image beginning at swath 54. During the printing operation, waveform 80 is not applied to any of the jetting heaters 60. Step S116 is continued for the duration of swath 54.

At step S118, the printing operation for current swath 54 is completed, and waveform 64 and waveform 100 are disabled.

At step S120 a determination is made as to whether any more swaths remain to be printed. If not, process flow proceeds to step S122, otherwise process flow returns to step S104.

At step S122, the print job is completed. Printhead carrier 30 with printhead 32 are translated back to the starting position in preparation for the next print job, at which time process flow would recommence at step S102.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of printing using a printhead, said printhead having a plurality of ink ejectors and a plurality of jetting heaters corresponding to said plurality of ink ejectors, comprising:
applying a first waveform to said plurality of jetting heaters prior to a printing operation to warm up said printhead to a desired printhead operating temperature;
applying a second waveform to a first portion of said plurality of jetting heaters during said printing operation to print an image without applying said first waveform to any of said plurality of jetting heaters; and
applying a third waveform different from said first waveform to a second portion of said plurality of jetting heaters different from said first portion during said printing operation to maintain said desired printhead operating temperature.

2. The method of claim 1, wherein said first waveform is a first non-nucleating waveform having a first at least one non-nucleating pulse, said second waveform is a nucleating waveform having at least one nucleating pulse, and said third waveform is a second non-nucleating waveform having a second at least one non-nucleating pulse.

3. The method of claim 2, wherein said third waveform is configured to prevent a voltage drop in said first portion of said plurality of jetting heaters for a duration of said at least one nucleating pulse.

4. The method of claim 2, further comprising synchronizing said third waveform with said second waveform such that said second at least one non-nucleating pulse does not overlap said at least one nucleating pulse.

5. The method of claim 2, said second waveform further having at least one non-nucleating pre-fire pulse that is applied to said first portion of said plurality of jetting heaters prior to said at least one nucleating pulse for conditioning ink in a portion of said plurality of ink ejectors corresponding to said first portion of said plurality of jetting heaters.

6. The method of claim 5, wherein said third waveform is configured to prevent a voltage drop in said first portion of said plurality of jetting heaters for a duration of said at least one nucleating pulse and for a duration of said at least one non-nucleating pre-fire pulse.

7. The method of claim 5, further comprising synchronizing said third waveform with said second waveform such that said second at least one non-nucleating pulse does not overlap any of said at least one nucleating pulse and said at least one non-nucleating pre-fire pulse.

8. The method of claim 1, wherein said third waveform is configured to prevent a voltage drop in said first portion of said plurality of jetting heaters.

9. The method of claim 1, wherein inside a current firing window, said first portion of said plurality of said jetting heaters is designated for ink ejection, and said second portion of said plurality of jetting heaters is not designated for ink ejection.

10. The method of claim 1, wherein said second portion of said plurality of jetting heaters is all of said plurality of jetting heaters except for said first portion of said plurality of jetting heaters.

11. The method of claim 1, wherein said third waveform provides less energy to a given jetting heater of said plurality of jetting heaters than does said first waveform.

12. An imaging apparatus comprising:
a print engine;
a printhead communicatively coupled to said print engine, said printhead having a plurality of ink ejectors and a plurality of jetting heaters corresponding to said plurality of ink ejectors; and
a controller communicatively coupled to said print engine, said controller being configured to execute instructions for printing using said printhead, said instructions including:
applying a first waveform to said plurality of jetting heaters prior to a printing operation to warm up said printhead to a desired printhead operating temperature;
applying a second waveform to a first portion of said plurality of jetting heaters during said printing operation to print an image without applying said first waveform to any of said plurality of jetting heaters; and
applying a third waveform different from said first waveform to a second portion of said plurality of jetting heaters different from said first portion during said printing operation to maintain said desired printhead operating temperature.

13. The imaging apparatus of claim 12, wherein said first waveform is a first non-nucleating waveform having a first at least one non-nucleating pulse, said second waveform is a nucleating waveform having at least one nucleating pulse, and said third waveform is a second non-nucleating waveform having a second at least one non-nucleating pulse.

14. The imaging apparatus of claim 13, wherein said third waveform is configured to prevent a voltage drop in said first portion of said plurality of jetting heaters for a duration of said at least one nucleating pulse.

15. The imaging apparatus of claim 13, further comprising said controller executing instructions to synchronize said third waveform with said second waveform such that said second at least one non-nucleating pulse does not overlap said at least one nucleating pulse.

16. The imaging apparatus of claim 13, said second waveform further having at least one non-nucleating pre-fire pulse that is applied to said first portion of said plurality of jetting heaters prior to said at least one nucleating pulse for conditioning ink in a portion of said plurality of ink ejectors corresponding to said first portion of said plurality of jetting heaters.

17. The imaging apparatus of claim 16, wherein said third waveform is configured to prevent a voltage drop in said first portion of said plurality of jetting heaters for a duration of said at least one nucleating pulse and for a duration of said at least one non-nucleating pre-fire pulse.

18. The imaging apparatus of claim 16, further comprising said controller executing instructions to synchronize said third waveform with said second waveform such that said second at least one non-nucleating pulse does not overlap any of said at least one nucleating pulse and said at least one non-nucleating pre-fire pulse.

19. The imaging apparatus of claim 12, wherein said third waveform is configured to prevent a voltage drop in said first portion of said plurality of jetting heaters.

20. The imaging apparatus of claim 12, wherein inside a current firing window, said first portion of said plurality of jetting heaters is designated for ink ejection, and said second portion is not designated for ink ejection.

21. The imaging apparatus of claim 12, wherein said second portion of said plurality of jetting heaters is all of said plurality of jetting heaters except for said first portion.

22. The imaging apparatus of claim 12, wherein said third waveform provides less energy to a given jetting heater of said plurality of jetting heaters than does said first waveform.
